(19) United States
(12) Patent Application Publication
(10) Pub. No.: US 2019/0034927 A1
(43) Pub. Date: Jan. 31, 2019

(54) PAYMENT TRANSACTION PROCESSING SYSTEMS AND METHODS

(71) Applicant: Mastercard International Incorporated, Purchase, NY (US)

(72) Inventors: Abhijeet Kumbhar, Pune (IN); Siddhant Singhal, Muzaffarnagar (IN); Akshit Kapoor, Pune (IN); Amit Kumar, Gorakhpur (IN)

(73) Assignee: Mastercard International Incorporated, Purchase, NY (US)

(21) Appl. No.: 15/997,893

(22) Filed: Jun. 5, 2018

(30) Foreign Application Priority Data
Jul. 31, 2017 (SG) 10201706219S

(51) Int. Cl. G06Q 20/40; G06Q 20/36

(52) U.S. Cl. CPC G06Q 20/401; G06Q 20/36

(57) ABSTRACT

Systems and methods for processing a transaction authorization request are disclosed. If a total transaction amount exceeds an available account balance or credit limit of a payment card associated with the transaction authorization request, an auxiliary payment account such as a wallet account linked to the payment card may be used to complete the transaction. Thus the transaction is partitioned into a payment card transaction and an auxiliary payment account transaction which have a combined transaction amount that corresponds to the total transaction amount.

### CROSS REFERENCE TO RELATED APPLICATIONS

This application claims priority to Singapore Application Serial No. 10201706219S, filed Jul. 31, 2017, which is incorporated herein by reference in its entirety.

### TECHNICAL FIELD AND BACKGROUND

The present disclosure relates to the processing of electronic payment transactions. In particular, it relates to processing transactions when a total transaction amount exceeds an available credit balance or account balance associated with a payment card.

Many consumers use payment cards such as credit cards and debit cards to pay for purchases. With most payment cards there is a limit to the amount that a customer can spend. This limit may be based on a remaining credit limit in the case of a credit card or the remaining account balance in the case of a debit card. Generally when a consumer attempts to make a purchase for an amount greater than this limit, a transaction authorization request generated by an acquirer bank for the purchase will be declined by the issuer bank of the payment card. In such cases, the consumer would have to either make part or all of the payment through cash or an alternative payment method, or not proceed with the purchase. Making the purchase via an alternative payment method generally involves a point of sale device at the merchant having to generate a new transaction and a new transaction authorization request being processed by the acquirer bank server.

### SUMMARY

In general terms, the present disclosure proposes incorporation of an additional functionality in a payment network server which allows for a user to make a partial payment using an auxiliary payment account such as a wallet account in the event that an initial payment authorization request is declined due to an insufficient remaining balance for a transaction.

According to a first aspect of the present invention, there is provided an apparatus for processing a payment transaction authorization request. The apparatus comprises: a computer processor and a data storage device, the data storage device having an a payment card transaction processing module; wallet information look up module; a transaction partition module; wallet provider interaction module; and a combined transaction approval request generation module comprising non-transitory instructions operative by the processor to: receive an acquirer payment transaction authorization request from an acquirer bank server, the acquirer payment transaction authorization request comprising an indication of a merchant transaction amount and a payment card account identifier of a payment card account; send a first payment card transaction authorization request to an issuer server associated with the payment card account; receive a first payment card transaction authorization response from the issuer server, the first payment card transaction authorization response indicting that the first payment card transaction authorization request is declined due to an available balance associated with the payment card account being less than the merchant transaction amount, the first payment card transaction authorization response further comprising an indication of the available balance associated with the payment card account; in response to receiving the first payment network transaction authorization response, determine an identifier of a payment wallet account associated with the payment card account; determine a partition of the merchant transaction amount into a first transaction amount and a second transaction amount, wherein the first transaction amount and the second transaction amount combined provide the merchant transaction amount and the second transaction amount is less than or equal to the available balance associated with the payment card account; generate a wallet transaction authorization request for the first transaction amount; send the wallet transaction authorization request to a server associated with a wallet provider for the payment wallet account; generate a second payment card transaction authorization request for the second transaction amount; send the second payment card transaction authorization request to the issuer server; receive a wallet payment authorization response from the server associated with the wallet provider indicating that the wallet transaction authorization request is approved; receive a second payment card transaction authorization response from the server associated with the wallet provider indicating that the second payment card authorization request is approved; and generate an acquirer payment authorization response indicating that the acquirer payment transaction is approved.

In some embodiments, an auxiliary account such as a payment card account is used to perform the function of the wallet account.

In an embodiment the data storage device further comprises a user interaction module comprising non-transitory instructions operative by the processor to generate a user prompt request message comprising instructions to cause a point of sale device to generate a user prompt and to receive a user response message indicating a request to process the merchant transaction as a partitioned transaction.

In an embodiment, the wallet information look up module comprises non-transitory instructions operative by the processor to determine an identifier of the wallet provider associated with the wallet account.

In an embodiment, the data storage device further comprises a user interaction module comprising non-transitory instructions operative by the processor to generate a combined transaction success indication message indicating that the wallet transaction and the second payment card transaction have been successfully authorized.

The combined transaction success indication message may be a text message or email message.

In an embodiment the wallet information look up module further comprises non-transitory instructions operative by the processor to look up wallet authorization information for the wallet account and the wallet provider interaction module further comprises non-transitory instructions operative by the processor to send the wallet authorization information to the server associated with the wallet provider.

In an embodiment the transaction partition module further comprises non-transitory instructions operative by the processor to determine the second transaction amount as the available balance associated with the payment card account.

According to a second aspect of the present invention there is provided a payment transaction processing method in a payment network server. The method comprises: receiving an acquirer payment transaction authorization request from an acquirer bank server, the acquirer payment transaction authorization request comprising an indication of a merchant transaction amount and a payment card account identifier of a payment card account; sending a first payment card transaction authorization request to an issuer server associated with the payment card account; receiving a first payment card transaction authorization response from the issuer server, the first payment card transaction authorization response indicting that the first payment card transaction authorization request is declined due to an available balance associated with the payment card account being less than the merchant transaction amount, the first payment card transaction authorization response further comprising an indication of the available balance associated with the payment card account; in response to receiving the first payment network transaction authorization response, determining an identifier of a payment wallet account associated with the payment card account; determining a division of the merchant transaction amount into a first transaction amount and a second transaction amount, wherein the first transaction amount and the second transaction amount combined provide the merchant transaction amount and the second transaction amount is less than or equal to the available balance associated with the payment card account; generating a wallet transaction authorization request for the first transaction amount; sending the wallet transaction authorization request to a server associated with a wallet provider for the payment wallet account; generating a second payment card transaction authorization request for the second transaction amount; sending the second payment card transaction authorization request to the issuer server; receiving a wallet transaction authorization response from the server associated with the wallet provider indicating that the wallet transaction authorization request is approved; receiving a second payment card transaction authorization response from the server associated with the wallet provider indicating that the second payment card authorization request is approved; and generating an acquirer payment authorization response indicating that the acquirer payment transaction is approved.

According to a yet further aspect, there is provided a non-transitory computer-readable medium. The computer-readable medium has stored thereon program instructions for causing at least one processor to perform operations of a method disclosed above.

### BRIEF DESCRIPTION OF THE DRAWINGS

Embodiments of the invention will now be described for the sake of non-limiting example only, with reference to the following drawings in which:

FIG. 1 is a block diagram showing a system for processing payment transactions according to an embodiment of the present invention;

FIG. 2 is a block diagram showing a technical architecture of a payment network server for performing exemplary methods in accordance with an embodiment of the present invention;

FIGS. 3a and 3b are flow diagrams showing message flows in a method of processing a payment transaction in an embodiment of the present invention;

FIG. 4 is a flowchart showing a method of processing a payment transaction authorization request according to an embodiment of the present invention; and

FIG. 5 is a flowchart showing a method of generating data linking a payment card identifier with a wallet account identifier for use in an embodiment of the present invention.

### DETAILED DESCRIPTION

In the present disclosure, the term “payment card” is intended to mean a credit card or debit card account having an associated balance which may be a credit balance or a remaining credit limit in the case of a credit card and an account balance in the case of a debit card. The term “wallet account” is intended to mean an electronic wallet account such as those provided by “Paytm”, “Freecharge” or “Mobikwik”.

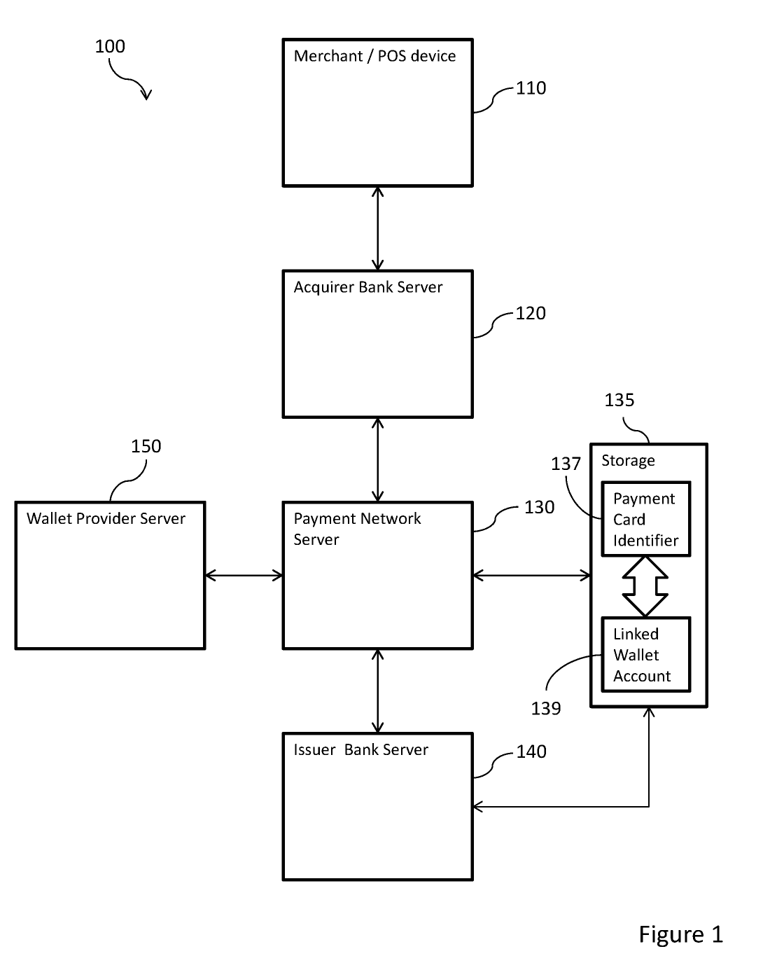

FIG. 1 is a block diagram showing a system for processing payment transactions according to an embodiment of the present invention. The system 100 comprises a merchant/point of sale (POS) device 110, an acquirer bank server 120, a payment network server 130, an issuer bank server 140 and a wallet provider server 150. A storage device 135 is linked to the payment network server 130.

The merchant/POS device 110 is an electronic device which allows a merchant to take payments by payment card. The merchant/POS device 110 is operable to electronically read payment cards and transfer payment card data to the acquirer bank server 120. The merchant/POS device 110 may also comprise a user interface such as a display and keypad or a touchscreen display which allows interaction with the user.

The acquirer bank server 120 is a server associated with a banking organisation which processes payment card transactions on behalf of the merchant. The payment network server 130 is a server associated with a payment network such as the Banknet payment network operated by MasterCard. As shown in FIG. 1 the payment network server 130 is coupled to the acquirer bank server 120, the issuer bank server 140, and the wallet provider server 150. The issuer bank server 140 is a server associated with a bank that has issues payment cards. The wallet provider server 150 is a server associated with an electronic wallet provider. Communication between the servers may take place via any type of network, for example, a virtual private network (VPN), the Internet, a local area and/or wide area network (LAN and/or WAN), and so on.

The storage device 135 coupled to the payment network server 130 stores data linking a payment card identifier for a payment card issued by the issuer bank with a wallet account identifier for a wallet associated with the wallet provider server 150.

In order to initiate payment transactions with the merchant, a customer or user may present his payment card to the merchant/POS device 110. When the transaction is processed, the merchant/POS device 110 communicates with the acquirer bank server 120 in order to authorize the transaction. The acquirer bank server 120 routes the authorization request to the payment network server 130. The payment network server 130 routes the transaction authorization request to the issuer bank server 140.

The issuer server 140 processes the transaction authorization request and generates a transaction authorization response indicating whether the transaction is approved or not. If the payment transaction is approved, then the issuer server 140 sends a message indicating this to the payment network server 130 which routes this message to the acquirer bank server 120.

Embodiments of the present invention are concerned with the scenario in which the issuer bank server 140 generates a transaction authorization response indicating that the transaction is refused. If a total transaction amount exceeds an available account balance or credit limit of a payment card associated with the transaction authorization request, a wallet account provided by the wallet provider server 150 and linked to the payment card may be used to complete the transaction. Thus the transaction is partitioned into a payment card transaction and a wallet transaction which have a combined transaction amount that corresponds to the total transaction amount. Such embodiments are described in more detail below.

In some embodiments, an auxiliary payment account may be used to complete the transaction. This auxiliary payment account may be implemented as a payment card account such as a debit card account, a credit card account or a pre-paid account.

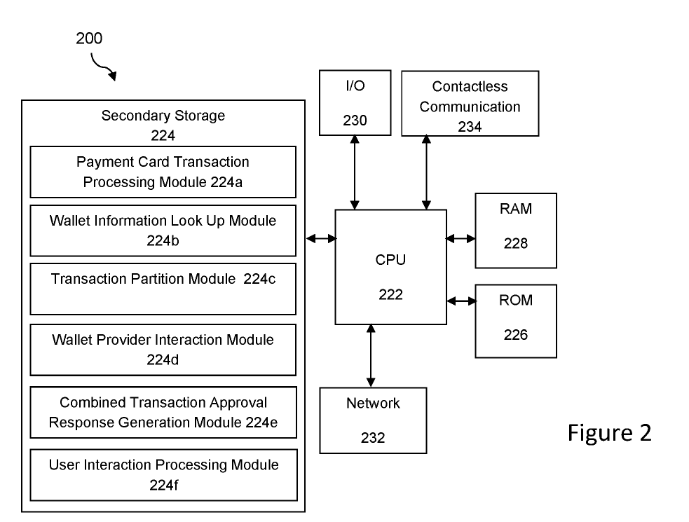

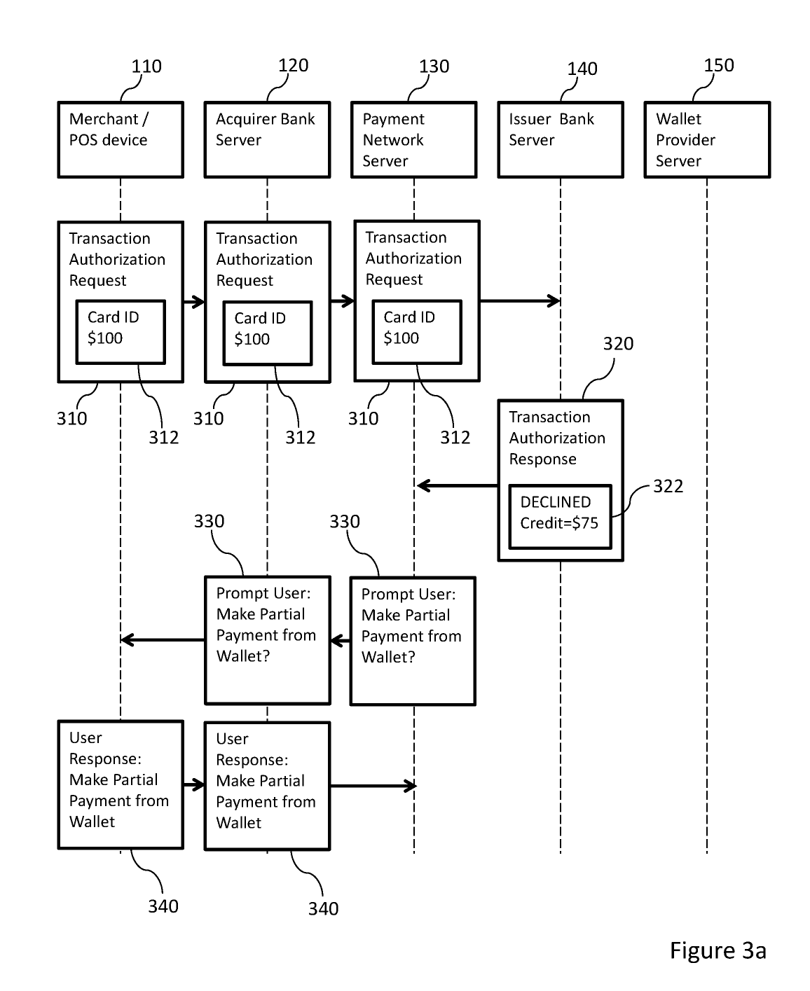

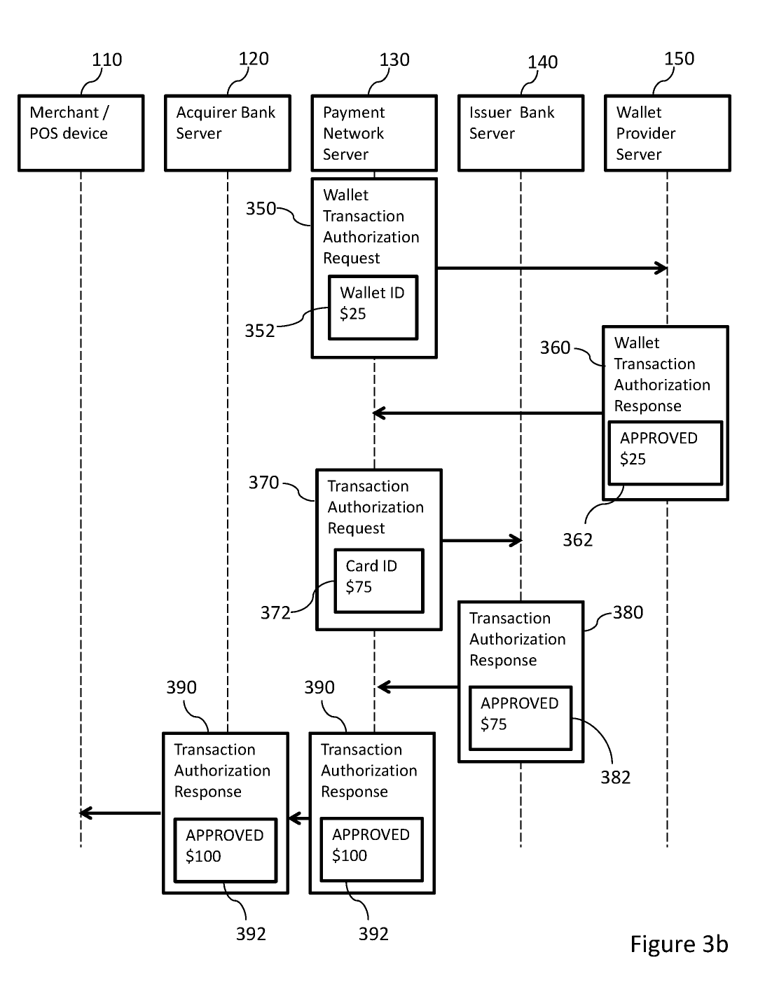

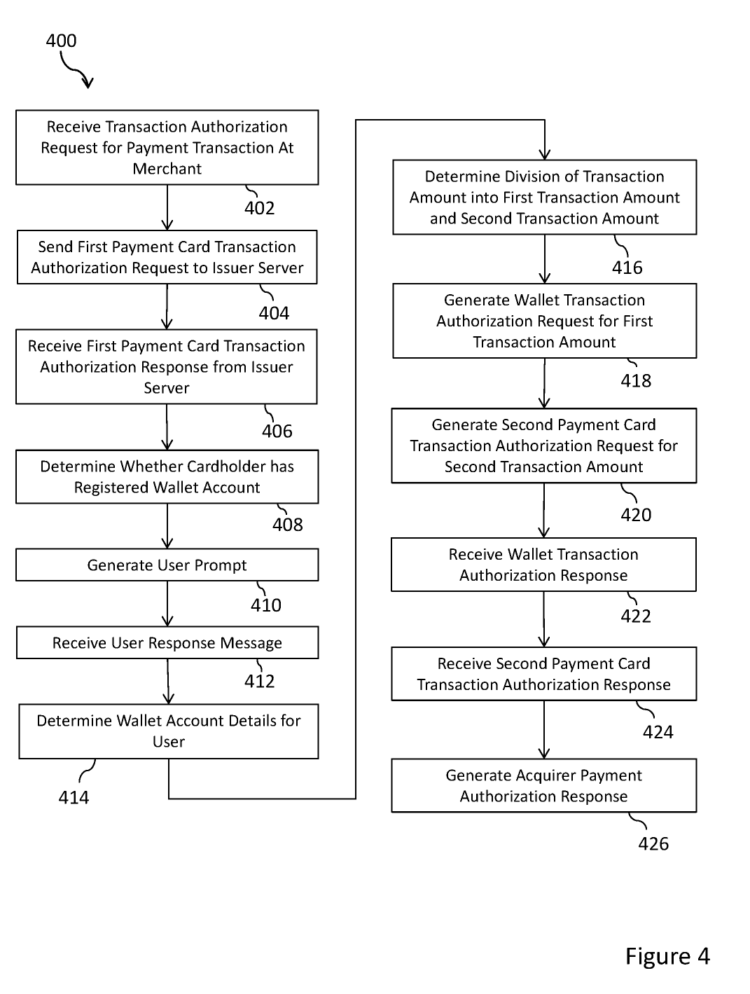

FIG. 2 is a block diagram showing a technical architecture 200 of the payment network server 130 for performing exemplary method 400 which is described below with reference to FIGS. 3a, 3b and 4. Typically, the method 400 is implemented by a computing device having a data-processing unit. The block diagram as shown in FIG. 2 illustrates a technical architecture 200 of a computing device which is suitable for implementing one or more embodiments herein.

The technical architecture 200 includes a processor 222 (which may be referred to as a central processor unit or CPU) that is in communication with memory devices including secondary storage 224 (such as disk drives), read only memory (ROM) 226, random access memory (RAM) 228. The processor 222 may be implemented as one or more CPU chips. The technical architecture 220 may further comprise input/output (I/O) devices 230, and network connectivity devices 232.

The secondary storage 224 is typically comprised of one or more disk drives or tape drives and is used for non-volatile storage of data and as an over-flow data storage device if RAM 228 is not large enough to hold all working data. Secondary storage 224 may be used to store programs which are loaded into RAM 228 when such programs are selected for execution. In this embodiment, the secondary storage 224 has a payment card transaction processing module 224a, a wallet information look up module 224b, a transaction partition module 224c, a wallet provider interaction module 224d, a combined transaction approval response generation module 224e and a user interaction processing module 224f comprising non-transitory instructions operative by the processor 222 to perform various operations of the method of the present disclosure. As depicted in FIG. 2, the modules 224a-224f are distinct modules which perform respective functions implemented by the payment network server 130. It will be appreciated that the boundaries between these modules are exemplary only, and that alternative embodiments may merge modules or impose an alternative decomposition of functionality of modules. For example, the modules discussed herein may be decomposed into sub-modules to be executed as multiple computer processes, and, optionally, on multiple computers. Moreover, alternative embodiments may combine multiple instances of a particular module or sub-module. It will also be appreciated that, while a software implementation of the modules 224a-224f is described herein, these may alternatively be implemented as one or more hardware modules (such as field-programmable gate array(s) or application-specific integrated circuit(s)) comprising circuitry which implements equivalent functionality to that implemented in software. The ROM 226 is used to store instructions and perhaps data which are read during program execution. The secondary storage 224, the RAM 228, and/or the ROM 226 may be referred to in some contexts as computer readable storage media and/or non-transitory computer readable media.

I/O devices 230 may include printers, video monitors, liquid crystal displays (LCDs), plasma displays, touch screen displays, keyboards, keypads, switches, dials, mice, track balls, voice recognizers, card readers, paper tape readers, or other well-known input devices.

The network connectivity devices 232 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), and/or other air interface protocol radio transceiver cards, and other well-known network devices. These network connectivity devices 232 may enable the processor 222 to communicate with the Internet or one or more intranets. With such a network connection, it is contemplated that the processor 222 might receive information from the network, or might output information to the network in the course of performing the above-described method operations. Such information, which is often represented as a sequence of instructions to be executed using processor 222, may be received from and outputted to the network, for example, in the form of a computer data signal embodied in a carrier wave.

The processor 222 executes instructions, codes, computer programs, scripts which it accesses from hard disk, floppy disk, optical disk (these various disk based systems may all be considered secondary storage 224), flash drive, ROM 226, RAM 228, or the network connectivity devices 232. While only one processor 222 is shown, multiple processors may be present. Thus, while instructions may be discussed as executed by a processor, the instructions may be executed simultaneously, serially, or otherwise executed by one or multiple processors.

It is understood that by programming and/or loading executable instructions onto the technical architecture 200, at least one of the CPU 222, the RAM 228, and the ROM 226 are changed, transforming the technical architecture 200 in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

Although the technical architecture 200 is described with reference to a computer, it should be appreciated that the technical architecture may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the technical architecture 200 to provide the functionality of a number of servers that is not directly bound to the number of computers in the technical architecture 200. In an embodiment, the functionality disclosed above may be provided by executing the application and/or applications in a cloud computing environment. Cloud computing may comprise providing computing services via a network connection using dynamically scalable computing resources. A cloud computing environment may be established by an enterprise and/or may be hired on an as-needed basis from a third party provider.

Various operations of an exemplary method 400 will now be described with reference to FIGS. 3a, 3b and FIG. 4 in respect of processing a transaction. It should be noted that enumeration of operations is for purposes of clarity and that the operations need not be performed in the order implied by the enumeration.

FIGS. 3a and 3b are flow diagrams showing message flows between the entities shown in FIG. 1 in a method of processing a payment transaction in an embodiment of the present invention. FIG. 4 is a flowchart showing a method of processing a transaction according to an embodiment of the present invention. The method 400 shown in FIG. 4 is implemented on the payment network server 130 shown in FIG. 1.

As shown in FIG. 3a, initially, the merchant/POS device 110 generates a transaction authorization request 310 corresponding to a transaction. In this example, the transaction is for $100. As shown in FIG. 3a, the transaction authorization request 310 comprises an indication of the transaction amount and an identifier of the payment card 312.

The merchant/POS device 110 then sends the transaction authorization request 310 to the acquirer bank server 120. The acquirer bank server 120 forwards the transaction authorization request 310 to the payment network server 130.

Referring now to FIG. 4, in step 402, the payment card transaction processing module 224a of the payment network server 130 receives the transaction authorization request 310 for the payment transaction at the merchant. In step 404, the payment card transaction processing module 224a of the payment network server 130 sends the transaction authorization request 310 to the issuer bank server 140. The payment network server 130 may use the payment card identifier to determine the issuer bank which issued the payment card and route the transaction authorization request 310 to the issuer bank server 140 corresponding to that issuer bank.

As shown in FIG. 3a, in this example, the issuer bank server 140 generates a transaction authorization response 320 indicating that the transaction authorization request 310 is declined. The transaction authorization response 320 includes an indication of the available credit 322. In this case the available credit is $75.

Returning to FIG. 4, in step 406, the payment network server 130 receives the payment card authorization response 320 indicating that the transaction authorization request has been declined because the available credit balance is less than the transaction amount.

In step 408, the wallet information look up module 224b of the payment network server 130 determines whether the cardholder has a registered wallet account. This is accomplished by the wallet information look up module 224b accessing the storage 135 coupled to the payment network server 130 to determine if a linked wallet account 139 exists for the payment card identifier 137 associated with the payment authorization request 310.

If the cardholder has a registered wallet account, in step 410, the user interaction processing module 224f of the payment network server 130 generates a user prompt indication 330 which is sent by the user interaction processing module 224f of the payment network server 130 to the acquirer bank server.

As shown in FIG. 3a, the acquirer bank server 120 forwards the user prompt indication 330 to the merchant/POS device 110. The merchant/POS device 110 generates a prompt to the user to determine if they wish to make a partial payment from the linked wallet account.

As shown in FIG. 3a, in response to the user prompt, the user enters a response. The user response indicates that the user wishes to make a partial payment from the wallet. The user response 340 is sent by the merchant/POS device 110 to the acquirer bank server 120 and then sent by the acquirer bank server 120 to the payment network server 130.

In some embodiments steps 410 and 412 may be omitted. The cardholder may instead pre-authorize payments from the wallet account at the time of registering the wallet account. This pre-authorization may include a threshold below which a user prompt for the cardholder is not generated. For example, this threshold may be USD 25.

In some embodiments, the partial payment may be made from an account other than a wallet account. As such the wallet account may be considered as an auxiliary payment account which may be implemented as a debit card account, a credit card account or a pre-paid card or other type of payment account.

If the user does not have a linked wallet account, or if the user indicates that they do not wish to use the linked wallet account to make the partial payment, then the transaction authorization request is declined and the user either abandons the transaction or makes payment using a different payment method.

In step 412, the payment network server 130 receives the user response 340 indicating that the user wishes to make part of the payment using the linked wallet account. In step 414, the wallet information look up module 224b of the payment network server 130 looks up the wallet account details from the storage 135.

In step 416, the transaction partition module 224c of the payment network server 130 determines a partition of the transaction amount into a first amount which will be included in a wallet transaction and a second amount which will be included in a payment card transaction. In some embodiments, the transaction partition module 224c determines the split by taking the second amount as the credit limit for the payment card and then determines the first amount as the remainder of the total amount included in the original transaction authorization request 310 received from the merchant/POS device 110. In the example shown in FIG. 3b, the split is determined in this way so the first amount is $25 and the second amount is $75.

In step 418, the wallet provider interaction module 224d of the payment network server 130 generates a wallet transaction authorization request 350. As shown in FIG. 3b, the wallet transaction authorization request 350 comprises an indication of the wallet identifier and an indication of the wallet transaction amount 352. In this example, the wallet transaction amount is $25. The wallet provider interaction module 224d may determine the identity of the wallet provider from the information stored in the storage 135 and route the wallet transaction authorization request 350 to the wallet provider server 150 corresponding to that wallet provider.

As shown in FIG. 3b, the wallet transaction authorization request 350 is sent to the wallet provider server 150. The wallet provider server 150 determines whether to authorize the wallet transaction authorization request 350. This authorization may involve determining if there is sufficient balance in the wallet account and determining whether the payment network server 130 has been verified and/or authorized by the user to initiate wallet transactions.

In response to the wallet transaction authorization request 350, the wallet provider server 150 generates a wallet transaction authorization response 360. As shown in FIG. 3b, in this example, the wallet transaction authorization response includes data 362 indicating that the wallet transaction is approved and an indication of the transaction amount which in this example is $25.

In step 420, the payment card transaction module 224a of the payment network server 130 generates a second payment card transaction authorization request 370. The second payment card transaction authorization request 370 corresponds to the second amount determined in step 416. As shown in FIG. 3b, the second payment card transaction authorization request 370 includes an indication 372 of the second amount which in this example is $75.

In response to the second payment card transaction authorization request 370, the issuer bank server 140 generates a second payment card transaction authorization response 380. As shown in FIG. 3b, the second payment card transaction authorization response 380 includes an indication 382 that the transaction is approved which also indicates the transaction amount which in this example is $75.

In step 422, the wallet provider interaction module 224d of the payment network server 130 receives the wallet transaction authorization response 360. In step 424, the payment card transaction processing module 224a of the payment network server 130 receives the second payment card transaction authorization response.

In step 226, in response to receiving the wallet transaction authorization response 360 indicating that the wallet transaction authorization request 350 is approved and the second payment card transaction authorization response 380 indicating that the second payment card transaction authorization request 370 is approved, the combined transaction approval response generation module 224e of the payment network server 130 generates a combined transaction authorization response 390. As shown in FIG. 3b, the combined transaction authorization response 390 includes an indication 392 that the transaction is approved for the total amount of the original transaction authorization request 310 generated by the merchant/POS device 110. In this case this amount is $100.

In some embodiments, the user interaction processing module 224f of the payment network server 130 may generate a user message such as a text message or an email message and send the user message to a device associated with the user. The user message indicates that the transaction has been authorized and may also include an indication of the first and second transaction amounts.

The combined transaction authorization response 390 is sent by the payment network server 130 to the acquirer bank server 120. The acquirer bank server 120 forwards the combined transaction authorization response 390 to the merchant/POS device 110.

Upon receiving the combined transaction authorization response 390, the merchant/POS device 110 proceeds to process the transaction which in the example shown in FIGS. 3a and 3b is for $100.

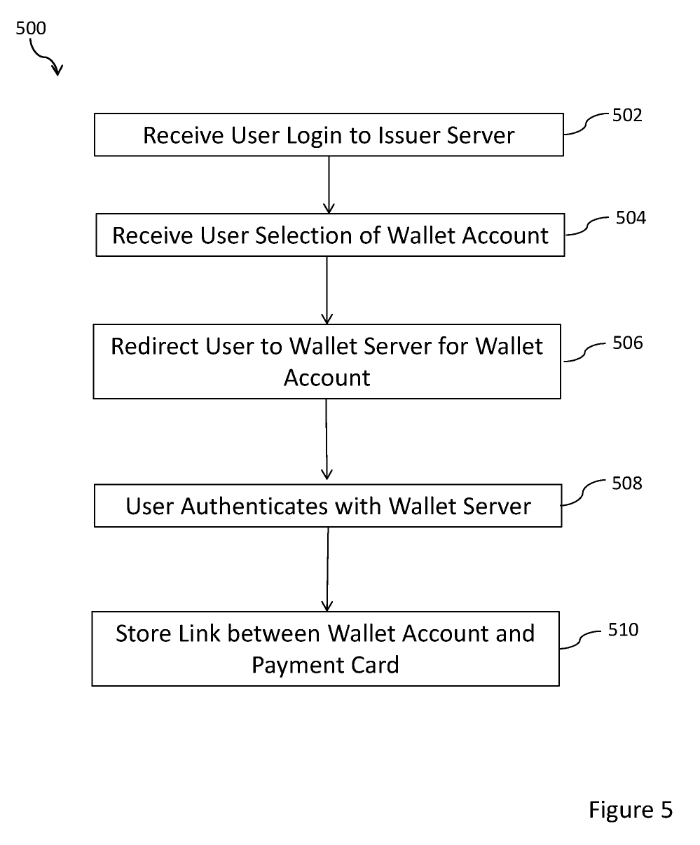

As described above, the payment network server 130 uses the data linking payment card identifiers 137 to wallet accounts 139 stored in the storage 135 to identify a wallet account linked to the payment card. This data may be generated in response to the user registering a wallet account to be linked with a payment card. This process is described in more detail with reference to FIG. 5 below.

FIG. 5 shows a method of generating data linking a payment card identifier with a wallet account identifier for use in an embodiment of the present invention. The method 500 shown in FIG. 5 may be implemented by the issuer bank server 140 shown in FIG. 1 to store the data stored in the storage device 135.

In step 502, the issuer bank server 140 receives a user login. The user may log in to an internet banking website using a secure log in. This secure log in may allow the user to provide an indication of the payment card account which they wish to link to a wallet account.

In step 504, a user selection of a wallet account is received. Step 504 may comprise allowing the user to select from a number of wallet account providers and receiving a user selection of one of the wallet providers.

In step 506, the user is redirected to the wallet provider server 150 corresponding to the selected wallet account. In step 508, the user authenticates with the wallet provider server. Step 508 may comprise the user entering a password or other login data. In some embodiments this step may also involve second factor authentication such as a text message or email message being sent to a registered device for the user and the user entering a code contained in the text message or email message.

In step 510 if the user is successfully authenticated, a link between the user payment card and the user wallet account is stored in the storage 135. The storage 135 may also store authentication information to be provided to the wallet provider server 150 to authenticate wallet transactions. Alternatively or additionally, the wallet provider server 150 may store an indication that the payment network server 130 has been authorized and authenticated to carry out transactions on the wallet account.

Whilst the foregoing description has described exemplary embodiments, it will be understood by those skilled in the art that many variations of the embodiment can be made within the scope and spirit of the present invention.

1. An apparatus for processing a payment transaction authorization request, the apparatus comprising:
a computer processor and a data storage device, the data storage device comprising non-transitory instructions operative by the processor to:
receive an acquirer payment transaction authorization request from an acquirer bank server, the acquirer payment transaction authorization request comprising an indication of a merchant transaction amount and a payment card account identifier of a payment card account;
send a first payment card transaction authorization request to an issuer server associated with the payment card account;
receive a first payment card transaction authorization response from the issuer server, the first payment card transaction authorization response indicating that the first payment card transaction authorization request is declined due to an available balance associated with the payment card account being less than the merchant transaction amount, the first payment card transaction authorization response further comprising an indication of the available balance associated with the payment card account;
in response to receiving the first payment network transaction authorization response, determine an identifier of an auxiliary payment account associated with the payment card account;
determine a partition of the merchant transaction amount into a first transaction amount and a second transaction amount, wherein the first transaction amount and the second transaction amount combined provide the merchant transaction amount and the second transaction amount is less than or equal to the available balance associated with the payment card account;
generate an auxiliary payment account transaction authorization request for the first transaction amount;
send the auxiliary payment account transaction authorization request to a server associated with an auxiliary account provider for the auxiliary payment account;
generate a second payment card transaction authorization request for the second transaction amount;
send the second payment card transaction authorization request to the issuer server;
receive an auxiliary account payment authorization response from the server associated with the auxiliary account provider indicating that the auxiliary payment account transaction authorization request is approved;
receive a second payment card transaction authorization response from the issuer server indicating that the second payment card authorization request is approved; and
generate an acquirer payment authorization response indicating that the acquirer payment transaction is approved.

2. An apparatus according to claim 1, wherein the auxiliary payment account is a payment wallet account.

3. An apparatus according to claim 1, the data storage device further comprising non-transitory instructions operative by the processor to generate a user prompt request message comprising instructions to cause a point of sale device to generate a user prompt and to receive a user response message indicating a request to process the merchant transaction as a partitioned transaction.

4. An apparatus according to claim 1, wherein the storage device comprises non-transitory instructions operative by the processor to determine an identifier of the wallet provider associated with the wallet account.

5. An apparatus according to claim 1, wherein the data storage device further comprises non-transitory instructions operative by the processor to generate a combined transaction success indication message indicating that the wallet transaction and the second payment card transaction have been successfully authorized.

6. An apparatus according to claim 4, wherein the combined transaction success indication message is a text message or email message.

7. An apparatus according to claim 1, wherein storage device further comprises non-transitory instructions operative by the processor to look up auxiliary account authorization information for the auxiliary payment account and non-transitory instructions operative by the processor to send the auxiliary account authorization information to the server associated with the wallet provider.

8. An apparatus according to claim 1, wherein the storage device further comprises non-transitory instructions operative by the processor to determine the second transaction amount as the available balance associated with the payment card account.

9. A payment transaction processing method in a payment network server, the method comprising:
receiving an acquirer payment transaction authorization request from an acquirer bank server, the acquirer payment transaction authorization request comprising an indication of a merchant transaction amount and a payment card account identifier of a payment card account;
sending a first payment card transaction authorization request to an issuer server associated with the payment card account;
receiving a first payment card transaction authorization response from the issuer server, the first payment card transaction authorization response indicating that the first payment card transaction authorization request is declined due to an available balance associated with the payment card account being less than the merchant transaction amount, the first payment card transaction authorization response further comprising an indication of the available balance associated with the payment card account;
in response to receiving the first payment network transaction authorization response, determining an identifier of an auxiliary payment account associated with the payment card account;
determining a division of the merchant transaction amount into a first transaction amount and a second transaction amount, wherein the first transaction amount and the second transaction amount combined provide the merchant transaction amount and the second transaction amount is less than or equal to the available balance associated with the payment card account;
generating an auxiliary payment account transaction authorization request for the first transaction amount;
sending the auxiliary payment account transaction authorization request to a server associated with an auxiliary payment account provider for the auxiliary payment account;
generating a second payment card transaction authorization request for the second transaction amount;
sending the second payment card transaction authorization request to the issuer server;
receiving an auxiliary payment account transaction authorization response from the server associated with the auxiliary payment account provider indicating that the auxiliary payment account transaction authorization request is approved;
receiving a second payment card transaction authorization response from the server associated with the wallet provider indicating that the second payment card authorization request is approved; and
generating an acquirer payment authorization response indicating that the acquirer payment transaction is approved.

10. A method according to claim 9, wherein the auxiliary payment account is a payment wallet account.

11. A method according to claim 9, further comprising generating a user prompt request message comprising instructions to cause a point of sale device to generate a user prompt; and receiving a user response message indicating a request to process the merchant transaction as a partitioned transaction.

12. A method according to claim 9, further comprising determining an identifier of the auxiliary payment account provider associated with the auxiliary payment account.

13. A method according to claim 9, further comprising generating a combined transaction success indication message indicating that the auxiliary payment account transaction and the second payment card transaction have been successfully authorized.

14. A method according to claim 13, wherein the combined transaction success indication message is a text message or email message.

15. A method according to claim 9, further comprising looking up auxiliary payment account authorization information for the auxiliary payment account and to sending the auxiliary payment account authorization information to the server associated with the auxiliary account provider.

16. A method according to claim 9, wherein the second transaction amount is determined as the available balance associated with the payment card account.

17. A non-transitory computer readable medium having stored thereon program instructions for causing at least one processor to perform a method according to claim 9.
